(19) United States
(12) Patent Application Publication
(10) Pub. No.: US 2012/0251887 A1
(43) Pub. Date: Oct. 4, 2012

(54) Carbon-Coated Magneli-Phase TinO2n-1 Nanomaterials and a Method of Synthesis Thereof

(75) Inventor: Wei-Qiang Han, East Setauket, NY (US)

(73) Assignee: Brookhaven Science Associates, LLC, Upton, NY (US)

(21) Appl. No.: 13/438,085

(22) Filed: Apr. 3, 2012

Related U.S. Application Data
(60) Provisional application No. 61/471,561, filed on Apr. 4, 2011.

(51) Int. Cl. H01M 4/48; H01B 1/04; B05D 5/12; B82Y 99/00; B82Y 30/00

(52) U.S. Cl. 429/231.5; 252/507; 427/77; 977/788; 977/948

(57) ABSTRACT

A novel Magnéli phase nanomaterial with carbon coating is disclosed. The present Magnéli phase material, which can form a nanowire, a nanobelt, a nanoparticle, a nanocrystal, or a nanosheet, includes at least a Magnéli phase core having a substoichiometric composition of titanium oxide having a formula TiₙO₂ₙ₋₁, where n is between 4 and 10, and at least a carbon-based outer shell surrounding the Magnéli phase core. The shape-features of the carbon-coated Magnéli phase material of the present invention ensure that at least one dimension of it is nanoscale, and therefore has a high surface area. By having the high surface area, the Faradaic reaction can be processed more efficiently, and consequently attain higher capacity, higher power-density, and cycling stability. The present disclosure further encompasses a method of synthesizing these nanoscale Magnéli phase materials.

### CROSS-REFERENCE TO A RELATED APPLICATION

This application claims the benefit under 35 U.S.C. 119(e) of U.S. Provisional Application No. 61/471,561 filed on Apr. 4, 2011, the content of which is incorporated herein in its entirety.

### STATEMENT OF GOVERNMENT LICENSE RIGHTS

The present invention was made with Government support under contract number DE-AC02-98CH10886 awarded by the U.S. Department of Energy. The United States. Government has certain rights in this invention.

### I. FIELD OF THE INVENTION

This invention relates to the field of nanomaterials. In particular, the invention relates to nanoscale Magnéli phase TiₙO₂ₙ₋₁ and a method of synthesizing these nanomaterials by applying a carbon coating.

### II. BACKGROUND

Magnéli phases form a homologous series TiₙO₂ₙ₋₁ with two dimensional chains of octahedral TiO₂ and every layer missing oxygen atoms to accommodate the loss of stoichiometry. See, for example, Andersson, et al., Acta Chem. Scand, 11, 1641, 1957; Smith, et al., J. Appl. Electrochem. 28, 1021, 1998; Han et al., Appl. Phys. Lett. 92, 203117, 2008; each of which is incorporated herein by reference in its entirety. These Magnéli phases exhibit a high electronic conductivity comparable to that of graphite and their end members, TiO₂ and Ti₁₀O₁₉, show marked differences in their crystalline structures as well as in their magnetic and electric properties. The crystalline structure of the Magnéli phases can be viewed as rutile-type slabs of infinite extension and different thickness, separated by shear planes with a corundum-like atomic arrangement. When moving from TiO₂ to Ti₁₀O₁₉ in the Ti—O phase diagram, the d band occupation across the series increases and the material electronic structure changes. The changing electronic structure has profound consequences in the temperature dependence of physical properties such as the magnetic susceptibility and the electrical conductivity.

Typically, Magnéli phases are formed by heating titanium dioxide in a reducing atmosphere at high temperature, e.g., >800° C. However, no matter what the size of the starting material, i.e., bulk or nanoscale, the final products are usually larger than sub-micrometer. This larger than sub-micrometer size of Magnéli phases have lower surface area that contributes to less efficient Faradaic reaction and lower capacity, which limits the performance of these materials in electrical storage.

Thus, it is desirable to synthesize Magnéli phases that would offer high surface area, efficient Faradaic reaction, high capacity, high power-density, and cycling stability as electrodes and for other applications.

### SUMMARY

A novel Magnéli phase nanomaterial with carbon coating has been synthesized. The shape-features of the present carbon-coated Magnéli phase material ensure that at least one dimension of it is nanoscale, and therefore has a high surface area. By having the high surface area, the Faradaic reaction can be processed more efficiently, and consequently attain higher capacity, higher power density and cycling stability. A method of synthesizing these nanoscale Magnéli phase materials is also described.

The Magnéli phase material, which can form a nanowire, a nanobelt, a nanoparticle, a nanocrystal, or a nanosheet, at the minimum includes a Magnéli phase core and a carbon-based outer shell surrounding the Magnéli phase core.

The Magnéli phase core can have a substoichiometric composition of titanium oxide having a formula TiₙO₂ₙ₋₁, where n is between 4 and 10. In one exemplary embodiment, the substoichiometric composition of titanium oxide has a formula Ti₉O₁₇. In another exemplary embodiment, the substoichiometric composition of titanium oxide has a formula Ti₆O₁₁. In yet another exemplary embodiment, the substoichiometric composition of titanium oxide has a formula Ti₄O₇. However, the final composition is mainly dependent on reduction temperature. The core can have a size ranging from several nanometers to several hundreds of nanometers. In one embodiment, the core has a diameter, as measured across the shortest cross-section, of about 20 nm to about 200 nm, with about 20 nm to about 80 nm being preferred. In one embodiment, the core can further be doped with alkali metals, transition metals, non-metals, or halogens, including, but not limited to, Li, Na, K, B, C, N, F, Al, Si, P.S. Ca, Sc, V, Cr, Mn, Fe, Co, Ni, Cu, and Zn.

The outer shell surrounding the Magnéli phase core of the Magnéli phase nanomaterial can have one or more carbon layers. In a preferred embodiment, the number of carbon layers ranges from 1 to 30, with 3 to 24 being preferred and 3 to 12 being more preferred.

An electrode, preferably an anode, although a cathode is also envisioned, composed of a Magnéli phase nanomaterial, a conductive additive, and a binder is described herein. In one embodiment, the composition of the nanomaterial, additive, and binder is about 60% to 80% of nanomaterial, 10% to 30% of additive, and 5% to 15% of binder. In a preferred embodiment the composition of nanomaterial, additive, and binder is 70:20:10.

An electrochemical cell, i.e., a battery, having a cathode, an anode, and an electrolyte solution is also described. In this embodiment, the anode, the cathode, or both are composed of the Magnéli phase nanomaterial, a conductive additive, and a binder. In one embodiment, the electrochemical cells include, but are not limited to, a lithium ion battery, a hybrid electrochemical cell (HEC), a lead-acid battery, a fuel cell, and other batteries and conductors.

A method for synthesizing carbon-coated Magnéli phase nanomaterials is also described. The method includes exposing a nanoscale titanium-based compound selected from titania or hydrogen titanate to a carbon source under either dry or wet chemistry methods. If dry chemistry is utilized, i.e., free of solutions or solvents, the nanoscale titanium-based compound is exposed to a gaseous carbon source under elevated temperature, e.g., 400-800° C., and a sufficient coating can be achieved within 1 minute to 60 minutes. Alternatively, if wet chemistry is utilized, the nanoscale titanium-based compound is exposed to the carbon source dissolved in an applicable solvent or solution under elevated temperature, e.g., 100-300° C., preferably under pressure to avoid evaporation of the solvent, and a sufficient coating can be achieved within 2 to 6 hours.

The method for synthesizing carbon-coated Magnéli phase nanomaterials further includes reducing the carbon-coated titanium-based compound at elevated temperatures ranging between 800° C. and 1200° C. under a reducing atmosphere, e.g., hydrogen, carbon monoxide, nitrogen, or a combination thereof, for about 0.5 hour to 20 hours to yield carbon-coated Magnéli phase nanomaterials. The carbon-coated Magnéli phase material retains the scale of the starting titanium-based compound and has a Magnéli phase core with a substoichiometric composition of titanium oxide having a formula TiₙO₂ₙ₋₁, where n is between 4 and 10. However, in one embodiment, n in the substoichiometric composition can be inversely proportional to the temperature applied during reduction. The generated carbon-coated Magnéli phase material further has an outer shell made from one or more carbon layers surrounding the Magnéli phase core. In one embodiment, the number of carbon layers can range from 1 to 30. In certain embodiments the carbon source can be selected from an alkane(s), alkene(s), or alkyne(s) for use in the dry chemistry approach, or sugar(s) for use in the wet chemistry approach. In a preferred embodiment, the alkane is methane (CH₄), ethane (C₂H₆), propane (C₃H₈) or butane (C₄H₁₀), the alkene is ethylene (C₂H₄), propene (C₃H₆), or butylenes (C₄H₈), the alkyne is acetylene (C₂H₂) or cyclopropene (C₃H₄), and the sugar is sucrose, lactose or fructose. The titania is selected from the group consisting of anatase, rutile, brookite, bronze, and a combination or combinations thereof. The hydrogen titanate is selected from H₂Ti₃O₇, H₂Ti₂O₅.H₂O, H₂Ti₅O₁₁.H₂O, H₂Ti₄O₉.19H₂O, (H₂O)_{0.25}Ti₄O₇(OH)₂, (H₂O)Ti₄O₇(OH)₂, H₂Ti₈O₁₇, H₂Ti₄O₉.H₂O, and a combination or combinations thereof. In one embodiment, the titanium-based compound can be doped with alkali metals, transition metals, non-metals, or halogens, including, but not limited to, Li, Na, K, B, C, N, F, Al, Si, P.S. Ca, Sc, V, Cr, Mn, Fe, Co, Ni, Cu, and Zn.

### BRIEF DESCRIPTION OF THE DRAWINGS

FIG. 1A shows an XRD spectrum of carbon-coated Ti₉O₁₇ nanobelts.

FIG. 1B shows an SEM image of carbon-coated Ti₉O₁₇ nanobelts.

FIGS. 1C and 1D show, respectively, low- and high-magnification TEM images of carbon-coated Ti₉O₁₇ nanobelts.

FIG. 1E shows a fast-Fourier transform electron-diffraction pattern of the nanobelt shown in FIG. 1D.

FIG. 2A illustrates reversible (Li+ removal) capacities of coin cells with the carbon-coated Ti₉O₁₇ nanobelts as the working electrodes and lithium metal as both the reference electrode and the counterelectrode. The cycling rate was C/10 based on theoretical capacity.

FIG. 2B illustrates a cyclic voltammogram of the carbon-coated Ti₉O₁₇ nanobelts at scan rates of (along the arrows) 0.1, 0.5, 1, 1.5, and 2 mV/s.

FIG. 2C illustrates a normalized anodic peak current with respect to the value at 0.1 mV s⁻¹, in which the lines are the fitted results.

FIG. 3A illustrates a cyclic voltammogram of the Ti₉O₁₇ activated carbon cell at scan rates of 5, 10, 20, 40, and 100 mV/s, where the insert figure shows the Ragone plot of power density vs. energy density, and the insert table shows the capacitance.

FIG. 3B illustrates cycling performance of the cell of FIG. 3A at 100 mV/s, where the insert shows the CV profiles at the first and 450^{th} cycles.

### DETAILED DESCRIPTION

Nanomaterials composed of Magnéli phase titanium oxide having a formula (1)

TiₙO₂ₙ₋₁, (1)

where n is between 4 and 10, and the Magnéli phase is surrounded by one or more carbon layers are described. This nanomaterial ensures that at least one dimension of it is nanoscale and, thus, has a high surface area. By having the high surface area, the present nanomaterial allows the Faradaic reaction to be processed more efficiently, and consequently attain higher capacity, higher power density, and cycling stability. In some embodiments, electrodes are made from these nanomaterials and the electrochemical systems that use such electrodes. In some embodiments, a method includes synthesizing these nanomaterials. The configuration and each aspect of the embodiments are discussed in detail below. It is to be understood, however, that those skilled in the art may develop other combinatorial, structural, and functional modifications without significantly departing from the scope of the instant disclosure.
I. Magnéli Phase Nanomaterials

The present Magnéli phase material, which can form a nanowire, a nanobelt, a nanoparticle, a nanocrystal, or a nanosheet, at the minimum includes a Magnéli phase core and a carbon-based outer shell surrounding the Magnéli phase core. For example, the nanobelts are long ribbon-like nanostructures.

The Magnéli phase core can have a substoichiometric composition of titanium oxide having a formula TiₙO₂ₙ₋₁, where n is between 4 and 10. In one exemplary embodiment, the substoichiometric composition of titanium oxide has a formula Ti₉O₁₇. In another exemplary embodiment, the substoichiometric composition of titanium oxide has a formula Ti₆O₁₁. In yet another exemplary embodiment, the substoichiometric composition of titanium oxide has a formula Ti₄O₇. The core, typically, has the size and shape that is near or almost the same as that of the starting material before the synthesis was undertaken. In one embodiment, the core can have a size ranging from a few to several hundred nanometers. In one embodiment, the core has a diameter, as measured across the shortest cross-section, of about 20 nm to about 200 nm, with about 20 nm to about 80 nm being more preferred. In one embodiment, the core can be further doped with alkali metals, transition metals, non-metals, or halogens, including, but not limited to, Li, Na, K, B, C, N, F, Al, Si, P.S. Ca, Sc, V, Cr, Mn, Fe, Co, Ni, Cu, and Zn.

The outer shell surrounding the Magnéli phase core of the Magnéli phase nanomaterial can have one or more carbon layers. In a preferred embodiment, the number of carbon layers ranges from 1 to 30, with 3 to 24 being preferred and 3 to 12 being more preferred.

### II. Electrodes and Electrochemical Cells

As with most batteries, the present electrochemical cell, preferably non-aqueous, has an outer case made of metal or other material(s) or composite(s). This case holds a positive electrode (cathode); a negative electrode (anode); a separator and an electrolytic solution, where the present Magnéli phase material(s) can be used in production of the anode and/or the cathode.

In one embodiment, both the anode and cathode are materials into which and from which lithium can migrate. For example, when the battery charges, ions of lithium move through the electrolyte from the positive electrode to the negative electrode and attach to the carbon. During discharge, the lithium ions move back to the cathode from the anode. Inside the case sheets, formed of for example, the positive electrode, the negative electrode, and the separator pressed together, are submerged in an organic solvent that acts as the electrolyte. The electrolyte is composed of one or more salts, one or more solvents, and, optionally, one or more additives.

In one embodiment, the electrode, either the anode or the cathode, of the present invention may include at least one of the Magnéli phase nanomaterials having a formula TiₙO₂ₙ₋₁ where n is between 4 and 10. With specific reference to the anode, it may further comprise a conductive additive such as a carbon- or lithium-based alloy. The carbon may be in the form of graphite such as, for example, mesophase carbon microbeads (MCMB). Lithium metal anodes may be lithium mixed metal oxide (MMOs) such as LiMnO₂ and Li₄Ti₅O₁₂. Alloys of lithium with transition or other metals (including metalloids) may be used, including LiAl, LiZn, Li₃Bi, Li₃Cd, Li₃Sd, Li₄Si, Li_{4.4}Pb, Li_{4.4}Sn, LiC₆, Li₃FeN₂, Li_{2.6}Co_{0.4}N, Li_{2.6}Cu_{0.4}N, and combinations thereof. The anode may further comprise an additional material such as a metal oxide including SnO, SnO₂, GeO, GeO₂, In₂O, In₂O₃, PbO, PbO₂, Pb₂O₃, Pb₃O₄, Ag₂O, AgO, Ag₂O₃, Sb₂O₃, Sb₂O₄, Sb₂O₅, SiO, ZnO, CoO, NiO, FeO, and combinations thereof. The anode may further comprise a polymeric binder. In a preferred embodiment, the binder may be polyvinylidene fluoride, styrene-butadiene rubber, polyamide or melamine resin, and combinations thereof.

With specific reference to the cathode, it may include one or more lithium metal oxide compound(s) with or without the Magnéli phase nanomaterials having a formula TiₙO₂ₙ₋₁, where n is between 4 and 10. In particular, the cathode may comprise at least one lithium mixed metal oxide (Li-MMO). Lithium mixed metal oxides contain at least one other metal selected from the group consisting of Mn, Co, Cr, Fe, Ni, V, and combinations thereof. For example the following lithium MMOs may be used in the cathode: LiMnO₂, LiMn₂O₄, LiCoO₂, Li₂Cr₂O₇, Li₂CrO₄, LiNiO₂, LiFeO₂, LiNiₓCo₁₋ₓO₂ (O<x<1), LiFePO₄, LiMn_{z}Ni_{1-z}O₂ (0<z<1; LiMn_{0.5}Ni_{0.5}O₂), LiMn_{0.33}Co_{0.33}Ni_{0.33}O2, LiMc_{0.5}Mn_{1.5}O₄, where Mc is a divalent metal; and LiNiₓCo_{y}Me_{z}O₂ where Me may be one or more of Al, Mg, Ti, B, Ga, or Si and 0<x, y, z<1. Furthermore, transition metal oxides such as MnO₂ and V₂O₅; transition metal sulfides such as FeS₂, MoS₂, and TiS₂; and conducting polymers such as polyaniline and polypyrrole may be present. The preferred positive electrode material is the lithium transition metal oxide, including, especially, LiCoO₂, LiMn₂O₄, LiNi_{0.8}Cu_{0.15}Al_{0.05}O₂, LiFePO₄, and LiNi_{0.33}Mn_{0.33}Cu_{0.33}O₂. Mixtures of such oxides may also be used. Similar to the anode, the cathode may further comprise a polymeric binder. In a preferred embodiment, the binder may be polyvinylidene fluoride, styrene-butadiene rubber, polyamide or melamine resin, and combinations thereof.

In one embodiment, the composition of the electrode encompasses the nanomaterial, the conductive additive, and the binder is about 60% to 80% of nanomaterial, 10% to 30% of additive, and 5% to 15% of binder. In a preferred embodiment the composition of nanomaterial, additive, and binder is 70:20:10.

Although, the preferred embodiment has been described with reference to the lithium ion based electrochemical cells, it is also envisioned that the present carbon-coated Magnéli phase materials can be successfully applied to hybrid electrochemical cells (HEC), lead-acid batteries, fuel cells, and other conductors.

### III. Method and Application

In some embodiments, a method for synthesizing the carbon-coated Magnéli phase nanomaterials is included. The method includes exposing nanosized titanium-based compounds selected from titania and hydrogen titanate to a carbon source, via a wet chemistry (see Example 5) or a dry chemistry method (see Examples 1-4). If dry chemistry is utilized, i.e., free of solutions or solvents, the nanoscale titanium-based compound is exposed to a gaseous carbon source under elevated temperature conditions, e.g., 400° C.-800° C., and a sufficient coating can be achieved within 1 minute to 60 minutes. Alternatively, if wet chemistry is utilized, the nanoscale titanium-based compound is exposed to the carbon source dissolved in an applicable solvent or solution under elevated temperature conditions, e.g., 100° C.-300° C., preferably under pressure to avoid evaporation of the solvent, and a sufficient coating can be achieved within 2 to 6 hours.

The method further includes reducing the carbon-coated titanium-based compound(s) under an elevated temperature that ranges between 800° C. and 1200° C. and under a reducing atmosphere, e.g., hydrogen (H₂), nitrogen (N₂), and/or carbon monoxide (CO), for about 0.5 to 20 hours. The generated carbon-coated Magnéli phase material retains the scale of the starting titanium-based compound and has a Magnéli phase core with a substoichiometric composition of titanium oxide having a formula TiₙO₂ₙ₋₁, where n is between 4 and 10. In one embodiment, n in the substoichiometric composition is inversely proportional to the temperature applied during the reduction step.

Without being bound by theory, it is anticipated that coating the nanomaterials made from titania or hydrogen titanate with carbon prevents or suppresses sintering or growth of the Magnéli phase core during the phase transformation from any one of titania or hydrogen titanate to the substoichiometric composition of titanium oxide, while maintaining the intact morphology of the nanomaterial. The reducing process converts the crystal structures of titania or hydrogen titanate into Magnéli phase substoichiometric composition of titanium oxide. The final Magnéli phase titanium oxide core generally retains the shape and size of the starting materials, or exhibits only a small change with the addition of one or more carbon (coating) layers. In one embodiment, the number of carbon layers can range from 1 to 30.

In one embodiment, the carbon source can be selected from, but not limited to, alkane(s), alkene(s) or alkyne(s) for dry chemistry approaches, or sugar(s) for wet chemistry approaches. In a preferred embodiment, the alkane is methane (CH₄), ethane (C₂H₆), propane (C₃H₈), or butane (C₄H₁₀), the alkene is ethylene (C₂H₄), propene (C₃H₆), or butylenes (C₄H₈), the alkyne is acetylene (C₂H₂) or cyclopropene (C₃H₄), and the sugar is sucrose, lactose, or fructose. The titania is selected from the group consisting of anatase, rutile, brookite, bronze, and a combination or combinations thereof. The hydrogen titanate is selected from H₂Ti₃O₇, H₂Ti₂O₅.H₂O, H₂Ti₅O₁₁.H₂O, H₂Ti₄O₉.19H₂O, (H₂O)_{0.25}Ti₄O₇(OH)₂, (H₂O)Ti₄O₇(OH)₂, H₂Ti₈O₁₇, and H₂Ti₄O₉.H₂O, and a combination or combinations thereof. In one embodiment, the titanium-based compound can be doped with alkali metals, transition metals, non-metals, or halogens, including, but not limited to, Li, Na, K, B, C, N, F, Al, Si, P.S. Ca, Sc, V, Cr, Mn, Fe, Co, Ni, Cu, and Zn.

While the present Magnéli phase nanomaterials and the electrodes and electrochemical cells based on such materials have been described in connection with what is presently considered to be the most practical and preferred embodiment, it is to be understood that the disclosure is not to be limited to the disclosed embodiments, but on the contrary, is intended to cover various modifications and equivalent arrangements included within the spirit and scope of the appended claims.

### EXAMPLES

The examples set forth below also serve to provide further appreciation of the invention but are not meant in any way to restrict the scope of the invention.

### Example 1

One gram of H₂Ti₃O₇ nanowires were placed inside an alumina crucible. The crucible was then placed in the hot zone of a thermal chemical vapor deposition (CVD) furnace under flowing ethylene (C₂H₄) (50 sccm), where “sccm” denotes standard cubic centimeters per minute at standard temperature and pressure (STP), and flowing hydrogen (H₂) (100 sccm). The temperature was raised from 25° C. to 700° C. in 8 minutes and kept at 700° C. for an additional 10 minutes. Thereafter, the flow of ethylene was closed off and the temperature was raised to 950° C. After 3 hours at 950° C., the crucible was removed from the thermal CVD furnace. A black product was collected from the crucible. The analysis revealed that the black product was the Magnéli phase Ti₉O₁₇ nanowires coated with carbon layers. The size and shape of the Ti₉O₁₇ nanowires were almost the same as that of the starting H₂TiO₃O₇ nanowires. The number of carbon-coating layers for different nanowires typically ranged from 3 to 25.

### Example 2

0.5 grams of H₂Ti₂O₅.H₂O nanowires were placed inside an alumina crucible. The crucible was then placed in the hot zone of a thermal CVD furnace under flowing acetylene (C₂H₂) (30 sccm) and flowing hydrogen (100 sccm). The temperature was raised from 25° C. to 550° C. in 6 minutes and kept at 550° C. for an additional 6 minutes. Thereafter, the flow of acetylene was closed off and the temperature was raised to 950° C. After 3 hours at 950° C., the crucible was removed from the thermal CVD furnace. A black product was collected from the crucible. The analysis revealed that the black product was the Magnéli phase Ti₉O₁₇ nanowires coated with carbon layers. The size and shape of the Ti₉O₁₇ nanowires were almost the same as that of the starting H₂Ti₂O₅.H₂O nanowires. The number of carbon-coating layers for different nanowires typically ranged from 2 to 15.

### Example 3

0.5 grams of H₂Ti₃O₇ nanowires were placed inside an alumina crucible. The crucible was then placed in the hot zone of a thermal CVD furnace under flowing ethylene (C₂H₄) (40 sccm) and flowing hydrogen (100 sccm). The temperature was raised from 25° C. to 700° C. in 8 minutes and kept at 700° C. for an additional 10 minutes. Thereafter, the flow of ethylene was closed off and the temperature was raised to 1050° C. After 3 hours at 1050° C., the crucible was removed from the thermal CVD furnace. A black product was collected from the crucible. The analysis revealed that the black product was the Magnéli phase Ti₄O₇ nanowires coated with carbon layers. The size and shape of the Ti₄O₇ nanowires differed slightly from the starting H₂TiO₃O₇ nanowires—they were shorter and had larger diameters. The number of carbon-coating layers for different nanowires typically ranged from 6 to 25.

### Example 4

0.2 grams of anatase TiO₂ nanoparticles were placed inside an alumina crucible. The crucible was then placed in the hot zone of a thermal CVD furnace under flowing ethylene (50 sccm) and flowing hydrogen (100 sccm). The temperature was raised from 25° C. to 700° C. in 8 minutes and kept at 700° C. for an additional 10 minutes. Thereafter, the flow of ethylene was closed off and the temperature was raised to 950° C. After 3 hours at 950° C., the crucible was removed from the thermal CVD furnace. A black product was collected from the crucible. The analysis revealed that the black product was the Magnéli phase Ti₉O₁₇ nanoparticles coated with carbon layers. The size and shape of the Ti₉O₁₇ nanoparticles were almost the same as the starting anatase TiO₂ nanoparticles. The number of carbon coating-layers for different nanoparticles typically ranged from 4 to 20.

### Example 5

0.35 grams of rutile TiO₂ nanoparticles and 3.5 grams of glucose (C₆H₁₂O₆) were placed into a Teflon® bottle with 80 ml of deionized water. The bottle was put inside an autoclave and heated at 175° C. for 4 hours. Afterwards, the bottle was removed from the autoclave and allowed to cool down. The mixture of nanoparticles, glucose, and water was then filtered and dried. The collected powder was placed in an alumina crucible. The crucible was then placed in the hot zone of a thermal CVD furnace under flowing hydrogen (100 sccm). The temperature was raised from 25° C. to 965° C. in 15 minutes and kept at 965° C. for an additional 3 hours. After 3 hours at 965° C., the crucible was removed from the thermal CVD furnace. A black product was collected from the crucible. The analysis revealed that the black product was the Magnéli phase Ti₆O₁₁ nanoparticles coated with carbon layers. The size and shape of the Ti₆O₁₁ nanoparticles were almost the same as the starting rutile TiO₂ nanoparticles. The number of carbon-coating layers was variable.

### Example 6

The precursors of H₂Ti₃O₇ nanobelts were prepared by a procedure reported in Han et al., Appl. Phys. Lett. 92, 203117, 2008, incorporated herein by reference in its entirety. The widths of the nanobelts ranged from 30 to 200 nm, and their thicknesses ranged from 15 to 40 nm with length up to 10 μm. The as-grown white H₂Ti₃O₇ nanobelts were put into an alumina crucible and placed in the hot zone of a thermal CVD furnace under flowing ethane (50 sccm) and hydrogen (100 sccm) while raising the temperature from 25° C. to 950° C. in 20 min. Thereafter, the flow of ethane was closed off and the temperature was maintained at 950° C. After 2 hours at 950° C., the crucible was removed from the thermal CVD furnace and a black product collected. The analysis revealed that the collected product comprised carbon-coated Magnéli phase Ti₉O₁₇ nanobelts.

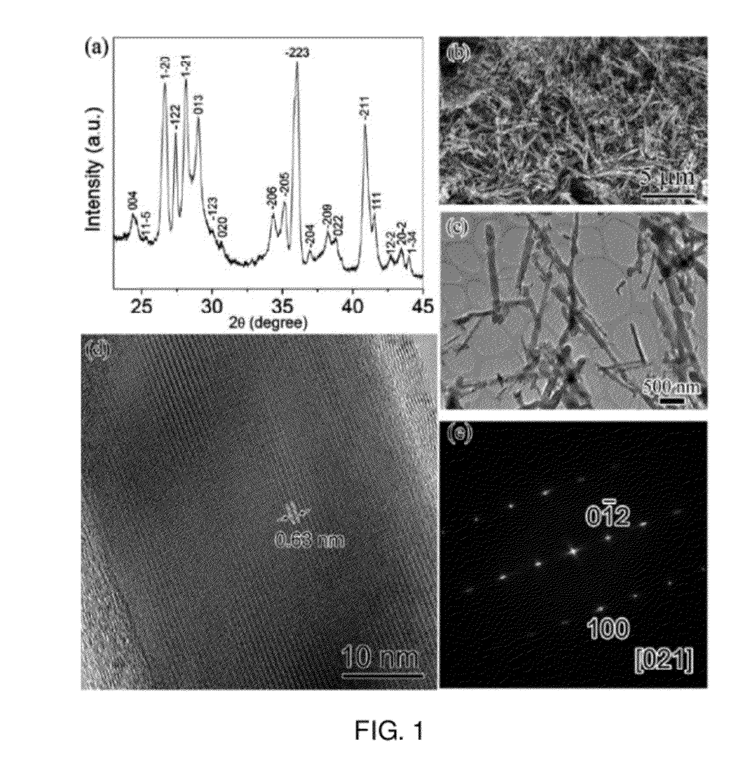

FIG. 1A is an X-ray diffraction (XRD) spectrum of the carbon-coated Magnéli phase Ti₉O₁₇ nanobelts prepared in Example 6. Its characteristic spectral peaks denote that the sample is triclinic Ti₉O₁₇ (a=5.57 Å, b=7.1 Å, c=22.15 Å, α=97.1°, β=131.0°, γ=109.8°). The scanning electron microscope (SEM) image, as shown in FIG. 1B, reveals that the samples are straight nanobelts, with smooth edges, and widths typically ranging from 30 to 200 nm, similar to the H₂Ti₃O₇ nanobelts of the starting material. FIG. 1C is a low-magnification transmission electron microscope (TEM) image of several nanobelts. FIG. 1D is a high-magnification TEM image of a part of a single-crystal nanobelt. The labeled distance is 6.3 Å, corresponding to the (012) plane of the triclinic mineral. The diameter of the nanobelt's core is 41 nm, and the thickness of the shell of the carbon layers is 4.5 nm. The number of layers for different carbon-coated nanobelts typically ranges from 4 to 24, which is larger than that (1-5) of the carbon-coated GaN nanowires described in Han et al., Adv. Mater. 14, 1560, 2002, which is incorporated herein by reference in its entirety, in which fabrication methane, rather than ethane, was used. The carbon coating formed before the temperature reached 950° C. This coating played a role in suppressing the sintering or growth of the core during the phase transformation from H₂Ti₃O₇ to the Magnéli phase TiₙO₂ₙ₋₁, and kept intact the nanobelt's morphology. FIG. 1E shows a fast-Fourier transform (FFT) electron-diffraction pattern of part of the Ti₉O₁₇ nanobelt depicted in FIG. 1D. The weight ratio of the carbon coating of the product was characterized using a thermogravimetric analyzer. Thermogravimetric analysis measurement shows that the mass ratio of the carbon coating is about 16%.

### Example 7

The same procedure was repeated as in Example 6 except the as-grown white H₂Ti₃O₇ nanobelts were placed in the hot zone of a thermal CVD furnace under flowing hydrogen (100 sccm), i.e., without ethylene as the reaction gas. Bare thick fibers of Ti₉O₁₇ were obtained with sizes that were about several micrometers.

### Example 8

The carbon-coated Magnéli phase Ti₉O₁₇ nanobelts produced in Example 6 were used as templates to test carbon-coated Magnéli phase nanomaterials as anodes for Li-ion batteries and hybrid electrochemical cells. The electrode films for measuring cell performance consisted of TiₙO₂ₙ₋₁, carbon black (Super P Li, TIMCAL, Westlake, Ohio), and a polyvinylidene fluoride binder. For the Magnéli phase Ti₉O₁₇ materials prepared in accordance with Example 6 (“coated”), the composition was 70:20:10. For the Magnéli phase Ti₉O₁₇ materials prepared in accordance with Example 7 (“bare”), the composition was 54:36:10. Copper foils (99.8%, Alfa) 0.025 mm thick served as the current collector. The electrolyte solution was 1.0 M LiPF₆ in ethylene carbonate/dimethyl carbonate (1:1 by volume, Novolyte, Cleveland, Ohio). A 20 μm polyolefin microporous membrane (Celgard 2320, Charlotte, N.C.) served as the separator. Laminated 2032-type coin cells were fabricated with electrode films/electrolyte saturated separators/lithium foils as the counterelectrode and reference electrode (0.75 mm thick, 99.9% metal basis, Alfa, Ward Hill, Mass.). The cells were cycled by a galvanostatic procedure and the voltage ranges were 0.5-3 V for the Magnéli samples, and the current applied was expressed as C/n, i.e., full charge or discharge of the theoretical capacity in n hours.

### Example 9

For characterizing the performance of TiₙO₂ₙ₋₁ as anode materials in hybrid electrochemical cells (HECs), laminated 2032-type coin cells were fabricated with electrode films/electrolyte-saturated separators/activated carbon electrodes similar to Example 8.

The carbon-electrode films consisted of activated carbon (Alfa, −20+50 mesh) and polyvinylidene fluoride binder with a weight composition of 90:10. The energy density was calculated as E=(1/2)CV², where C is the specific capacitance with respect to the TiO₂ mass and V is the voltage span. The power density was determined in accordance with P=E/Δt_{d}, in which Δt_{d} is the cathodic (discharge) scan time. Cyclic voltammetry was carried out at varying scan rates with the same coin cells. For hybrid electrochemical cells, the CV scan was between 0 and 2.5 V.

### Example 10

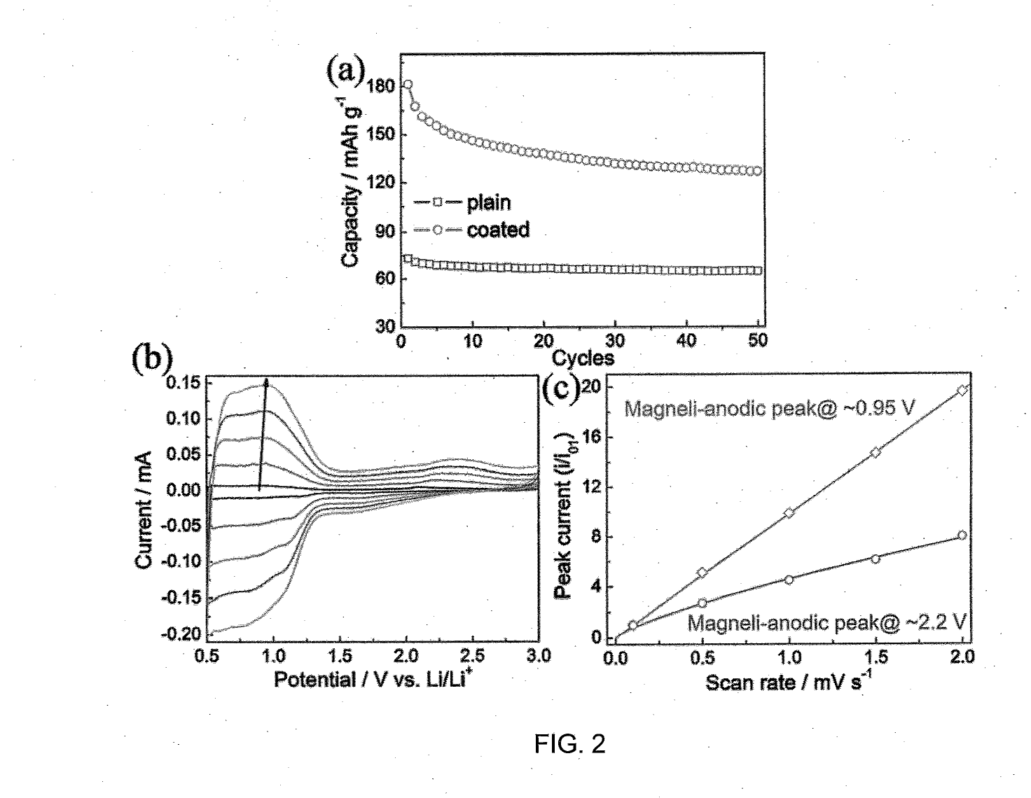

As illustrated in FIG. 2A, bare Magnéli Ti₉O₁₇ fibers of several micrometers (see Example 8) can deliver only a low capacity of about 70 mA·h·g⁻¹. However, the reversible capacity jumps considerably in the carbon-coated sample (see Example 6). The value has risen to about 182 mA·h·g⁻¹ and stabilizes at 130 mA·h·g⁻¹ after 50 cycles.

### Example 11

Cyclic voltammetry characterization was undertaken to understand Li-storage in the Ti₉O₁₇ nanobelts prepared in accordance with Example 8. FIG. 2B displays the voltammograms at varying scan rates (along the arrows) of 0.1, 0.5, 1, 1.5, and 2 mVs⁻¹. Each measurement exhibits a pair of cathodic/anodic peaks with a formal potential of 0.9 V versus Li/Li+ that is assignable to Ti₉O₁₇. The current response at lower voltages was attributed to electrolyte decomposition to form a solid electrolyte interface.

As illustrated in FIG. 2C, the normalized anodic peak currents in cyclic voltammograms were compared with the values obtained at the slowest scan rate of 0.1 mV/s. As demonstrated, for Ti₉O₁₇ nanobelts, the currents of the main peaks at ˜0.95 V scale with the first power of the scan rate, supporting a Faradaic pseudocapacitive charging-behavior,

i=dQ/dt=CdU/dt=Cv (2)

where C is capacitance, v is the scan rate, and Q is the charge. The pseudocapacitive-storage mechanism in Ti₉O₁₇ is reasonable, considering that the triclinic Magnéli phase TiₙO₂ₙ₋₁ lacks open structures in its lattices. Therefore, the Faradaic reaction occurring at the particles' surfaces mainly contributes to capacity. Accordingly, the special shape feature of the nanobelt ensures that at least one of its dimensions is nanoscale, and therefore has a high surface area, and thus the Faradaic reaction can be processed efficiently and, consequently, a high capacity attained. By contrast, only a fraction volume of the bulk Ti₉O₁₇, prepared in accordance with Example 7, was at the surface and could be involved in the Faradaic reaction. Therefore, the capacity performance of bulk Ti₉O₁₇ was relatively poor. Carbon coating was not only responsible for the morphology of Ti₉O₁₇ nanobelts, but is also helpful in the enhancement of the Faradaic reaction because of its high electrical conductivity, which facilitates the transportation of charges associated with the reaction along the current pathway and results in the improvement of cell performance.

### Example 12

The superior pseudocapacitive-storage behavior of carbon-coated Magnéli Ti₉O₁₇ nanobelts (see Example 6) makes it interesting to explore their application in HECs that integrate the high energy density of Li-incorporation anodes and the high power density of electric-double-layer cathodes.

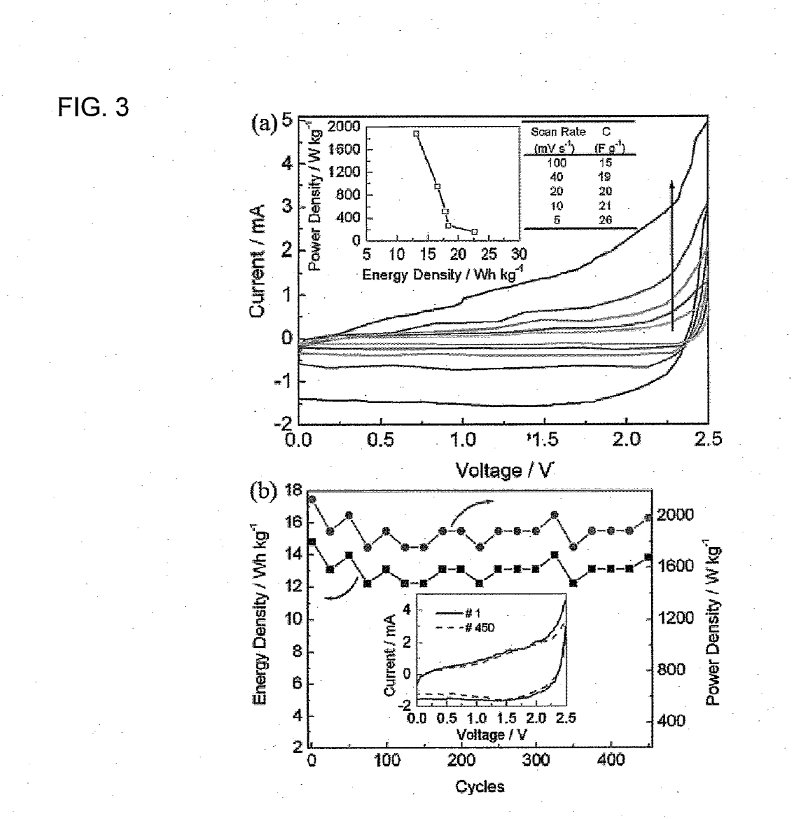

HECs with Ti₉O₁₇ as the anode were assembled and tested as shown in Example 9. Activated carbon was used as the cathode. As illustrated in FIG. 3A, the shape of the cyclic voltammograms was distorted, deviating from the rectangular shape of ideal carbon/carbon capacitors. This became more prominent with increasing scan rate due to the overlapping effect of the two different energy-storage mechanisms, viz., Li insertion into Ti₉O₁₇ and PF₆ adsorption onto carbon. A specific cell-capacitance of 26 F·g⁻¹ was displayed at a scan rate of 5 mV·s⁻¹, derived via Eq. (2) using the cathodic (discharge) current at 1.25 V. Thus, an energy density of 23 W·h·kg⁻¹ and a power density of 163 W·kg⁻¹ could be achieved. The merit of these HECs is seen in the Ragone plot (insert of FIG. 3A), where a power density as high as about 1900 W·kg⁻¹ was attainable, with an energy density higher than 10 W·h·kg⁻¹. Moreover, characteristically, the Ti₉O₁₇-carbon system displayed excellent cycling stability. After 450 cycles at 100 mV·s⁻¹, the energy and power densities were well maintained, and the CV curves were almost identical as illustrated in FIG. 3B. In summary, the initial reversible capacity of the Ti₉O₁₇ nanobelts attained 182 mA·h·g⁻¹. Cyclic voltammetry reveals the pseudocapacitive lithium-storage behavior of Magnéli-phase Ti₉O₁₇ nanobelts. They show high power density with excellent cycling stability in their application as hybrid electrochemical cells.

All publications and patents mentioned in the above specification are herein incorporated by reference in their entireties. Various modifications and variations of the described nanomaterials and methods will be apparent to those skilled in the art without departing from the scope and spirit of the invention. Although the disclosure has been described in connection with specific preferred embodiments, it should be understood that the invention as claimed should not be unduly limited to such specific embodiments. Indeed, those skilled in the art will recognize, or be able to ascertain using the teaching herein and no more than routine experimentation, many equivalents to the specific embodiments of the invention described herein. Such equivalents are intended to be encompassed by the following claims.

1. A nanomaterial comprising:
a Magnéli phase core and
an outer shell surrounding the Magnéli phase core,
wherein the Magnéli phase core comprises a substoichiometric composition of titanium oxide having a formula TiₙO₂ₙ₋₁, where n is between 4 and 10, and wherein the outer shell comprises one or more carbon layers.

2. The nanomaterial of claim 1, wherein the substoichiometric composition of titanium oxide has a formula Ti₉O₁₇, Ti₆O₁₁ or Ti₄O₇.

3. The nanomaterial of claim 1, wherein the one or more carbon layers ranges from 1 to 30.

4. The nanomaterial of claim 1, wherein the core has a diameter as measured across a shortest cross-section of the core that ranges from several nanometers to several hundred nanometers.

5. The nanomaterial of claim 1, wherein the nanomaterial is a nanowire, a nanobelt, a nanoparticle, a nanocrystal or a nanosheet.

6. An electrode comprising
a Magnéli phase nanomaterial;
a conductive additive; and
a binder,
wherein the Magnéli phase nanomaterial comprises a Magnéli phase core having a substoichiometric composition of titanium oxide with a formula TiₙO₂ₙ₋₁, where n is between 4 and 10; and an outer shell surrounding the Magnéli phase core having one or more carbon layers.

7. The electrode of claim 6, wherein the Magnéli phase nanomaterial is a nanowire, a nanobelt, a nanoparticle, a nanocrystal or a nanosheet.

8. The electrode of claim 6, wherein the substoichiometric composition of titanium oxide has a formula Ti₉O₁₇, Ti₆O₁₁ or Ti₄O₇.

9. The electrode of claim 6, wherein the one or more carbon layers ranges from 1 to 30.

10. The electrode of claim 6, wherein the electrode is an anode or a cathode operable in a lithium ion battery environment.

11. An electrochemical cell comprising:
a cathode,
an anode, and
an electrolyte solution,
wherein the anode comprises a Magnéli phase nanomaterial having a Magnéli phase core with a substoichiometric composition of titanium oxide having a formula TiₙO₂ₙ₋₁, where n is between 4 and 10; and an outer shell surrounding the Magnéli phase core having one or more carbon layers, a conductive additive, and a binder.

12. A method of synthesizing Magnéli phase nanomaterials, the method comprising: exposing a nanoscale titanium-based compound selected from titania and hydrogen titanate to a carbon source, thereby coating the nanoscale titanium-based compound with carbon;
reducing the carbon-coated titanium-based compound at an elevated temperature between 800° C. and 1200° C. under a reducing atmosphere; and
collecting a generated carbon-coated Magnéli phase nanomaterial,
wherein the carbon-coated Magnéli phase nanomaterial comprises a Magnéli phase core with a substoichiometric composition of titanium oxide having a formula TiₙO₂ₙ₋₁, where n is between 4 and 10, and an outer shell surrounding the Magnéli, phase core having one or more carbon layers.

13. The method according to claim 12, wherein the carbon source is selected from the group consisting of an alkane, alkene, alkyne, sugar, and a combination thereof.

14. The method according to claim 13, wherein the alkane is selected from the group consisting of methane (CH₄), ethane (C₂H₆), propane (C₃H₈), and butane (C₄H₁₀), wherein the alkene is selected from the group consisting of ethylene (C₂H₄), propene (C₃H₆), and butylenes (C₄H₈), wherein the alkyne is selected from the group consisting of acetylene (C₂H₂) and cyclopropene (C₃H₄), and wherein the sugar is selected from the group consisting of sucrose, lactose, and fructose.

15. The method according to claim 12, wherein the titania is selected from the group consisting of anatase, rutile, brookite, bronze, and a combination thereof.

16. The method according to claim 12, wherein the hydrogen titanate is selected from H₂Ti₃O₇, H₂Ti₂O₅.H₂O, H₂Ti₅O₁₁.H₂O, H₂Ti₄O₉.19H₂O, (H₂O)_{0.25}Ti₄O₇(OH)₂, (H₂O)Ti₄O₇(OH)₂, H₂Ti₈O₁₇, and H₂Ti₄O₉.H₂O, and a combination thereof.

17. The method according to claim 12, wherein the titanium-based compound is doped with a compound selected from the group consisting of Li, Na, K, B, C, N, F, Al, Si, P.S. Ca, Sc, V, Cr, Mn, Fe, Co, Ni, Cu, Zn, and a combination thereof.

18. The method according to claim 12, wherein the one or more carbon layers ranges from 1 to 30.

19. The method according to claim 12, wherein the reducing atmosphere is a flow of hydrogen, a carbon monoxide, or a combination thereof.

20. The method according to claim 12, wherein n in the substoichiometric composition of titanium oxide having the formula TiₙO₂ₙ₋₁ is inversely proportional to the temperature applied during the reducing step.

21. The method according to claim 12, wherein the carbon source comprises ethylene, the reducing atmosphere is a flow of hydrogen, and the elevated temperature during the reducing step is from 800° C. to 1200° C.

22. The method according to claim 12, wherein exposing the nanoscale titanium-based compound to the carbon source continues for about 1 minute to about 60 minutes.

23. The method according to claim 12, wherein reducing is carried out for about 0.5 hour to about 20 hours.

24. The method according to claim 12, wherein exposing the nanoscale titanium-based compound to the carbon source comprises allowing a gaseous carbon source to flow through the nanoscale titanium-based compound at an elevated temperature between about 400° C. and about 800° C. for about 1 minute to about 60 minutes.

25. The method according to claim 24, wherein the gaseous carbon source is selected from the group consisting of an alkane, alkene, alkyne, and a combination thereof.

26. The method according to claim 25, wherein the alkane is selected from the group consisting of methane (CH₄), ethane (C₂H₆), propane (C₃H₈), and butane (C₄H₁₀), wherein the alkene is selected from the group consisting of ethylene (C₂H₄), propene (C₃H₆), and butylenes (C₄H₈), and wherein the alkyne is selected from the group consisting of acetylene (C₂H₂) and cyclopropene (C₃H₄).

27. The method according to claim 12, wherein exposing the nanoscale titanium-based compound to the carbon source comprises combining the nanoscale titanium-based compound with the carbon source in a solution and heating said combination for about 2 hours to about 6 hours at an elevated temperature between about 100° C. and about 300° C.

28. The method according to claim 27, wherein the carbon source is a sugar.

29. The method according to claim 28, wherein the sugar is selected from the group consisting of sucrose, lactose, fructose, and a combination thereof.
